(19) United States
(12) Patent Application Publication
(10) Pub. No.: US 2022/0179146 A1
(43) Pub. Date: Jun. 9, 2022

(54) AN ILLUMINATED RETRACTABLE STRAP

(71) Applicant: MEDINOA OY, Espoo (FI)

(72) Inventors: Markku ERÄLUOTO, Espoo (FI); Hanna KUUSISTO, Espoo (FI)

(21) Appl. No.: 17/442,165

(22) PCT Filed: Mar. 26, 2020
(86) PCT No.: PCT/FI2020/050195

§ 371 Date: Sep. 23, 2021

(30) Foreign Application Priority Data
Mar. 28, 2019 (FI) 20195244

(51) Int. Cl. F21V 8/00; F21S 9/02; F21V 23/04; A01K 27/00; B65H 75/40; B65H 75/44; D07B 1/14

(52) U.S. Cl. CPC G02B 6/001; F21S 9/02; F21V 23/0471; F21V 23/0464; A01K 27/004; A01K 27/006; D07B 2201/2096; B65H 75/4471; D07B 1/148; B65H 2701/3915; B65H 2701/374; D07B 2201/2094; B65H 75/406

(57) ABSTRACT

An illuminated retractable strap assembly includes a rotatable strap spool, a strap structure having a first end fixed to the strap spool and a second end having a connector. The assembly includes a retraction mechanism for retracting the strap structure, the strap structure includes one or more elongated optical fibers for transmitting light between a first and a second end of the fibers and an outer covering allowing at least part of the light originating from the one or more elongated optical fibers to be transmitted through, a light source arranged in connection to the first end or to the second end of the fibers, and a power source.

### FIELD OF THE INVENTION

The present invention relates to an illuminated retractable strap.

### BACKGROUND OF THE INVENTION

Retractable belt barriers are used for guiding pedestrians and preventing unwanted intrusions as well as for restricting access to work or maintenance areas. The visibility of the belt barrier is obtained with contrasting colours and a text provided in the belt. However, without a sufficient illumination in the surroundings the belt barrier lacks visibility.

In the prior art it is known an illuminated pet leash where the light source comprises a strip of electroluminescent material. An electroluminescent wire is a thin copper wire coated in a phosphor. Light is produced through electroluminescence when an alternating current provided by a conventional DC battery and an inverter is applied to it.

One of the problems associated with the prior art is that the electroluminescent wire is not flexible enough to be moved smoothly in the spooling device during winding and unwinding. Further, the electroluminescent wire contains a copper wire inside. Each time the copper wire bends or flexes it is stressed. Copper has poor resistance to repeated stressing, even if the stress is kept low. Copper also has very low resistance to shear stress and it will deform.

Therefore, there is a need for an illuminated retractable strap which is resistant to wear.

### BRIEF DESCRIPTION OF THE INVENTION

An object of the present invention is to provide an illuminated retractable strap assembly so as to alleviate the above problems.

The objects of the invention are achieved by an illuminated retractable strap assembly which is characterized by what is stated in the independent claim. The preferred embodiments of the invention are disclosed in the dependent claims.

The invention is based on the idea of an illuminated retractable strap assembly, the assembly comprising a rotatable strap spool, a strap structure comprising a first end fixed to the strap spool and a second end comprising a connector. The assembly further comprises a retraction mechanism for retracting the strap structure around the strap spool. The strap structure comprises one or more elongated optical fibers for transmitting light between a first and a second end of the one or more elongated optical fibers, and an outer covering, the outer covering allowing at least part of the light originating from the one or more elongated optical fibers to be transmitted through. The assembly comprises a light source arranged in connection to the first end or to the second end of the fibers, and a power source electrically connected to the light source.

The elongated optical fiber comprises a side emitting optical fiber or a side glow optical fiber. In a side emitting fiber the light gradually escapes along the whole length of the fiber through a cladding surrounding the optical fiber core.

An advantage of the invention is that the illuminated retractable strap is resistant to wear, has reduced manufacturing costs and increased manufacturability. The strap comprises is flexible components allowing the strap to be moved smoothly in a spooling device during winding and unwinding.

The illuminated strap structure is visible even in poor illumination conditions in the surroundings.

The advantage of providing more elongated optical fibers, e.g. a bundle of optical fibers is that if a single optical fiber is damaged the other optical fibers still provide illumination to the strap.

In an embodiment of the invention the illuminated retractable strap assembly may comprise the outer covering fixed to the strap spool and to the connector. The first end of the one or more elongated optical fibers can then be fixed only to the strap spool. This reduces longitudinal stresses the one or more elongated optical fibers is subjected. Further, the length of the one or more elongated optical fibers can be less than the length of the outer covering.

The retraction mechanism is able to remove all slack from the strap structure. The retraction mechanism comprises a spring biased element, for instance, capable of automatically winding the strap structure to the strap spool. In an embodiment of the invention the one or more elongated optical fibers may comprise an outer surface provided with areas opaque to light. The opaque areas may be arranged at intervals proving a striped illumination, for instance. The areas opaque to light reduce the power required from the light source to illuminate the strap.

In an embodiment of the invention the illuminated retractable strap assembly may comprise the strap structure comprising elongated flexible strengthening fibers. The elongated flexible strengthening fibers may be arranged to surround the one or more elongated optical fibers, or the elongated flexible strengthening fibers and the one or more elongated optical fibers may be arranged to form a bundle. The strengthening fibers provide tensile strength to the strap structure. Tensile strength is defined as the resistance to longitudinal stresses or pull. The elongated flexible strengthening fibers are bendable but they stretch in the length direction only to a limited extent. The elongated flexible strengthening fiber stretches less in the length direction than the elongated optical fiber. Further, the strengthening fibers protect the one or more elongated optical fibers against damage and from been crushed.

Further, the elongated flexible strengthening fibers may be fixed to the strap spool and to the connector. The first end of the one or more elongated optical fibers can then be fixed only to the strap spool. This reduces longitudinal stresses the one or more elongated optical fibers is subjected. Additionally, the length of the one or more elongated optical fibers may be less than the length of the elongated flexible strengthening fibers.

In an embodiment of the invention the first end part of the strap structure comprises an indication that the first end of the strap structure is in vicinity. The indication may comprise a colour in the outer covering, the outer covering blocks the transmission of light originating from the one or more elongated optical fibers or a cladding of the one or more elongated optical fibers blocks the transmission of light originating from the one or more elongated optical fibers.

In an embodiment of the invention the illuminated retractable strap assembly comprises a position detector for measuring an amount of the illuminated retractable strap in the strap spool and changing a colour of the light source when the strap spool comprises a predefined amount of the illuminated retractable strap. In other words the colour of the light source changes to indicate that almost all the illuminated retractable strap is unwound. This improves control of a position of the connector.

In an embodiment of the invention the illuminated retractable strap assembly comprises a position detector for measuring an amount of the illuminated retractable strap in the strap spool, detecting rotation direction of the strap spool and changing a colour of the light source. In other words the light source has a different colour during unwinding, winding and when the illuminated retractable strap is not moving. In an alternative embodiment of the invention the light source has a different colour during unwinding and winding. This further improves control of a position of the connector. For instance, the position detector may comprise an electrical or optical or mechanical device for measuring an amount of the illuminated retractable strap in the strap spool and for measuring the rotation speed and direction of the strap spool. In an embodiment of the invention the assembly may comprise a reflector arranged in connection to the first or the second end of the one or more elongated optical fibers where the other of the first and the second ends comprises the light source, or the first or the second end of the one or more elongated optical fibers comprises a reflecting layer where the other of the first and the second ends comprises the light source. The reflective layer may comprise a polished metal surface or a coating comprising a metal coating or a dielectric reflecting coating.

In an embodiment of the invention the assembly may comprise two light sources. Then the first light source is arranged in connection to the first end of the one or more elongated optical fibers and the second light source is arranged in connection to second end of the one or more elongated optical fibers. The power source may be common to both light sources, where the supply line to the other light source runs in the strap structure, or each light source may have a separate power source.

In an embodiment of the invention the light source may comprise a light-emitting diode or a laser diode. As the power consumption of a light-emitting diode or a laser diode is low they are suitable for battery powered solutions. The light source may provide a blinking light or a steady light. Further, the light source may comprise a multicolor light-emitting diode.

In an embodiment of the invention a material of the elongated flexible strengthening fibers may comprise aramid, polyester, polyamide, polyethylene, ultra-high-molecular-weight polyethylene or polypropylene. The strengthening fibers have lightweight and high tensile strength. Tensile strength is defined as the resistance to longitudinal stresses or pull.

In an embodiment of the invention the outer covering may be transparent, translucent and/or it may comprise a braided structure. The outer covering may comprise reflective material or comprise a reflective surface to further intensify the illumination. The outer covering may comprise elongated strands.

The outer covering may comprise a fiber braided sleeving, for instance, giving protection to the one or more elongated optical fibers. The fiber braided sleeving may be made from continuously woven fiber, and the material may comprise a man-made fibre, a plastic-based material or a polymer-based fiber. In a braided structure, the one or more elongated optical fibers may be woven within the covering.

In an embodiment of the invention a material of the outer covering may comprise aramid, polyester, polyamide, polyethylene, ultra-high-molecular-weight polyethylene or polypropylene.

In an embodiment of the invention the outer covering or the one or more elongated optical fibres comprises a colour material. A colour light is easier to see in dark and thus less power is required to the light source. In a preferable embodiment of the invention the outer covering or the one or more elongated optical fibres comprises a neon colour material. This further decreases required power.

In an embodiment the outer covering and the light source have the same colour, or the one or more elongated optical fibres and the light source have the same colour. This further decreases required power.

In an embodiment of the invention the assembly may comprise the power source, the power source comprising a rechargeable power source. In one embodiment the rechargeable power source comprises a charging port, and electronics for charging. The charging port comprises an USB charging port, for instance.

In an embodiment of the invention the assembly is connected to a mains electricity.

In an embodiment of the invention the assembly comprises a rotating electrical connector arranged to provide electric power to the rotatable strap spool. In other words the rotating electrical connector is an electromechanical device that conducts electric power from a stationary to a rotating structure.

In an embodiment the assembly comprises a combined retraction mechanism and electric power conductor arranged to provide electric power to the rotatable strap spool.

In an alternative embodiment the rechargeable power source comprises a wireless charging component. A wireless charging component may be an induction coil, for instance.

In an embodiment of the invention the assembly may comprise a dynamo arranged in connection to the rotatable strap spool for charging the rechargeable power source. As an example, the dynamo can comprise a dynamo USB charger.

In an embodiment of the invention the strap structure may be a round in cross-section, or the strap structure may be a flat rectangular in cross-section or the strap structure may be an elliptical in cross-section or the strap structure may be a polygonal in cross-section.

In an embodiment of the invention the assembly may comprise a housing comprising a grip portion and a support portion for the strap spool. The strap spool is positioned within the support portion and the strap spool is rotatably supported on the support portion. The support portion comprises a strap opening.

In an embodiment the illuminated retractable strap assembly comprising a housing may comprise an animal tethering device, e.g. a retractable leash for animals, for instance. The connector in the second end of the strap structure is releasably attachable to a pet collar or to a pet harness. The connector may be a hook or a snap hook, as an example.

In an alternative embodiment the one or more elongated optical fibers extends to a pet collar or to a pet harness. Thus the pet collar or the pet harness are illuminated. The connector in the second end of the strap structure may be a buckle of the pet collar or the pet harness, as an example.

In an embodiment of the invention the one or more elongated optical fibers comprise an optical fiber connector for arranging a releasable connection between the one or more elongated optical fibers in the retractable leash and the one or more elongated optical fibers in the pet collar or the pet harness.

In an embodiment of the invention the strap opening in the housing may be widening outwards from the support portion for protecting the strap structure from wear caused by an outer edge of the strap opening. Additionally, or instead, the strap opening may comprise a flexible sleeve part attached to the strap opening and extending outwards from the support portion, for protecting the strap structure from wear caused by an outer edge of the strap opening.

In an embodiment of the invention the assembly may comprise a stop mechanism for stopping a rotation of the strap spool, and the stop mechanism comprises a button provided on the outer surface of the housing.

In an embodiment of the invention the assembly may comprise the light source arranged in connection to the first end of the one or more elongated optical fibers, the strap spool comprises a mounting surface, and the light source, the power source and electronics for controlling the light source are mounted to the mounting surface. The mounting surface is mounted to the center of the strap spool and it is rotating together with the strap spool.

In an embodiment of the invention the assembly may comprise an automatic twilight switch for turning on and turning off the light source, and/or an automatic motion sensor or a mechanical switch or a proximity sensor for detecting an unwinding and a retraction of the strap structure where the unwinding is turning on and the retraction is turning off the light source. In an embodiment of the invention the illuminated retractable strap assembly comprising a housing may comprise two or more rotatable strap spools each comprising a strap structure with a connector. The housing comprises the support portion for the two or more separate strap spools. The support portion may be a common support portion for the two or more rotatable strap spools, or the support portion may comprise two or more separate support portions. In the housing the two or more strap spools are positioned parallel or are arranged in a stack within the housing. The housing comprises two or more strap openings, one for each strap structure.

The assembly may comprise a housing comprising a grip portion and a support portion for the two or more rotatable strap spools. Then the two or more strap spools are positioned parallel or are arranged in a stack within the support portion of the housing.

In one embodiment of the invention at least a part of the housing is transparent or translucent. Thus the housing allows at least part of the light originating from the one or more elongated optical fibers to be transmitted through. This improves visibility and safety.

The invention can be applied to retractable belt barriers and to animal tethering devices, for instance.

### BRIEF DESCRIPTION OF THE DRAWINGS

The invention is described in detail by means of specific embodiments with reference to the enclosed drawings, in which

FIG. 1 shows an illuminated retractable strap assembly;

FIGS. 2a), b) and c) show a top view in cross-section showing a strap structure;

FIG. 3a), b) and c) show a top view in cross-section showing a strap structure;

FIG. 4 shows an end of the strap structure;

FIGS. 5a) and 5b) show an illuminated retractable strap assembly comprising a housing with a grip;

FIGS. 6a) and 6b) show a strap opening in a housing;

FIG. 7 shows a top view of an illuminated retractable strap assembly comprising a housing with a grip and with two strap spools;

FIG. 8 shows an elongated optical fiber.

FIG. 9 shows a rotating electrical connector.

FIG. 10 shows a combined retraction mechanism and electric power conductor.

FIG. 11 shows a spring biased element of a retraction mechanism

### DETAILED DESCRIPTION OF THE INVENTION

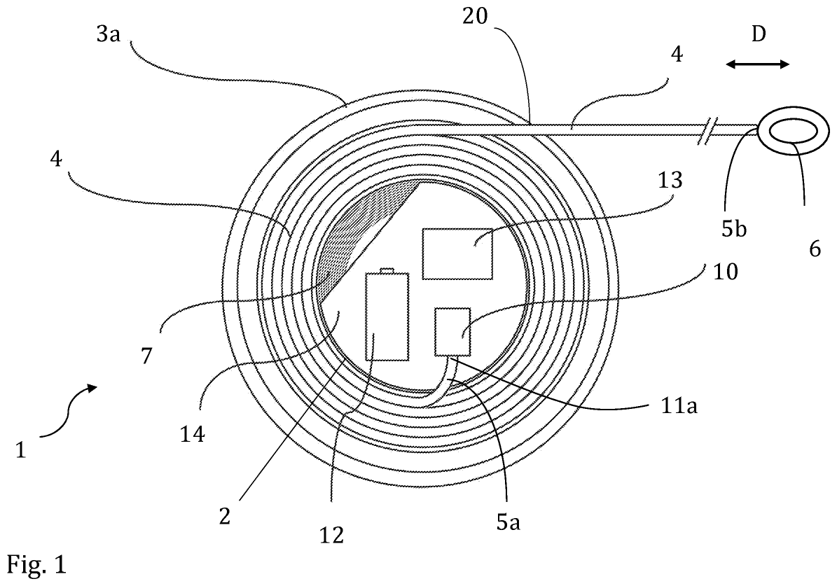

FIG. 1 shows an illuminated retractable strap assembly 1. The assembly 1 comprises a rotatable strap spool 2. In the FIG. 1 the rotatable strap spool 2 is arranged inside a housing 3a and supported to the housing 3a. The strap spool 2 can also be supported by an axle. The strap spool 2 can be rotated around a horizontal axis and then FIG. 1 shows a side view. The strap spool 2 can be rotated round a vertical axis and then FIG. 1 shows a top view.

The direction of the strap structure travel D is outwards from the strap spool 2 during unwinding and towards the strap spool 2 during retraction.

The strap structure 4 has a first end 5a which is fixed to the strap spool 2 and a second end 5b which has a connector 6 for connecting the strap structure 4 temporarily or permanently. A retraction mechanism 7 retracts the strap structure 4 around the strap spool 2. The retraction mechanism 7 can comprise a spring biased element where during unwinding the spring tension increases and any slack of the strap structure 4 is retracted to the strap spool 2.

The strap structure 4 comprises one or more elongated optical fibers 8 for transmitting light between a first 5a and a second end 5b of the one or more elongated optical fibers and an outer covering 9. The outer covering 9 allows at least part of the light originating from the one or more elongated optical fibers 8 to be transmitted through. A light source 10 is arranged in connection to the first end 11a of the one or more elongated optical fibers 8. The light source 10 can also be arranged in connection to the second end 11b of the one or more elongated optical fibers 8. It is also possible the assembly 1 comprises a first source 10 arranged in connection to the first end 11a of the fibers 8 and the second light source 10 is arranged in connection to second end 11b of the fibers 8.

A power source 12 is electrically connected to the light source 10 for powering the light source 10. The light source 10 can be a light-emitting diode or a laser diode, for instance. The assembly 1 comprises electronics 13 for controlling the light source 10, and if the power source 12 is rechargeable electronics 13 for charging the power source 12.

The assembly 1 further comprises a mounting surface 14 for the light source 10, the power source 12, and electronics 13. In FIG. 1 the mounting surface 14 is mounted to the center of the strap spool 2 and is rotating together with the strap spool 2.

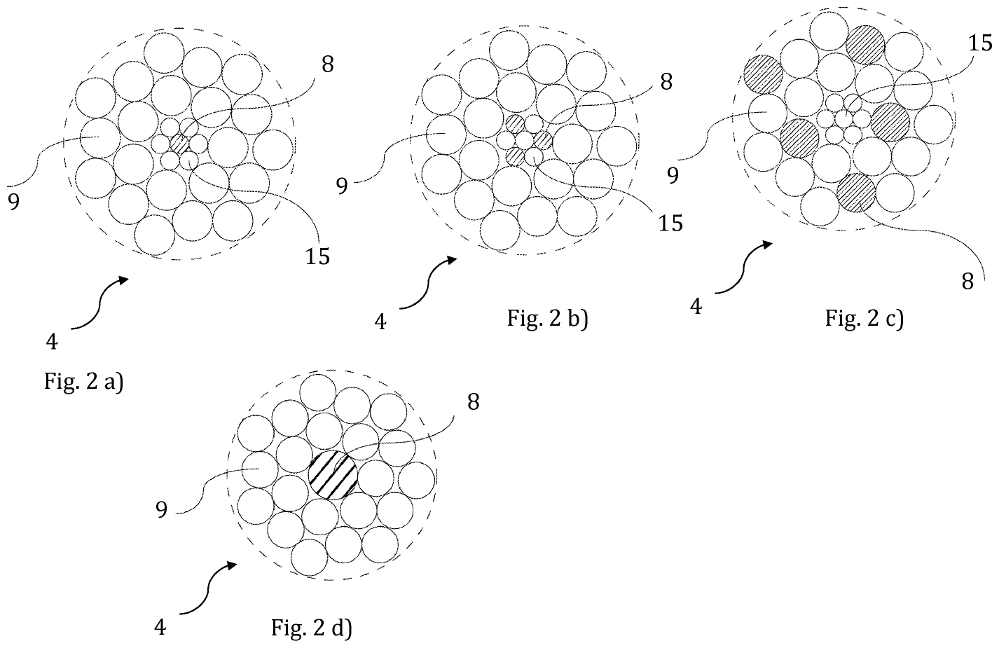

FIG. 2a), b) and c) show top views in cross-section showing some strap structure 4 examples. The strap structure 4 shown is substantially round in cross-section. The round shape of the strap structure 4 is indicated with a dotted line. The shown strap structures 4 comprise one or more elongated optical fibers 8, elongated flexible strengthening fibers 15 and an outer covering 9, which comprises elongated strands. The elongated strands run in the lengthwise direction of the strap structure 4.

FIG. 2a) shows a strap structure 4 where the structure 4 comprises elongated flexible strengthening fibers 15 arranged to surround the one or more elongated optical fibers 8. The one or more elongated optical fibers 8 are arranged in the middle of the strap structure 4. The outer covering 9 is arranged to surround the elongated flexible strengthening fibers 15, where the elongated strands run in the lengthwise direction of the strap structure 4.

FIG. 2b) shows a strap structure 4 where the one or more elongated optical fibers 8 and the elongated flexible strengthening fibers 15 are arranged in a free order to the middle part of the strap structure 4. The elongated flexible strengthening fibers 15 and the one or more elongated optical fibers 8 are arranged to form a bundle and the outer covering 9 is arranged to surround the bundle.

FIG. 2c) shows a strap structure 4 where the elongated flexible strengthening fibers 15 are arranged in the middle of the strap structure 4. The one or more elongated optical fibers 8 and the elongated strands of the outer covering 9 are arranged in a free order to surround the elongated flexible strengthening fibers 15. In the shown strap structure 4, at least one of the one or more elongated optical fibers 8 is arranged to form a part of the outer surface of the strap structure 4.

FIG. 2d) shows a strap structure 4 where the outer covering 9 is arranged to surround the one or more elongated optical fibers 8. The outer covering 9 stretches less in the length direction than the elongated optical fiber 8. The outer covering 9 is transparent or translucent.

The outer covering 9 in FIGS. 2a), b), c) and d) may comprise a braided structure.

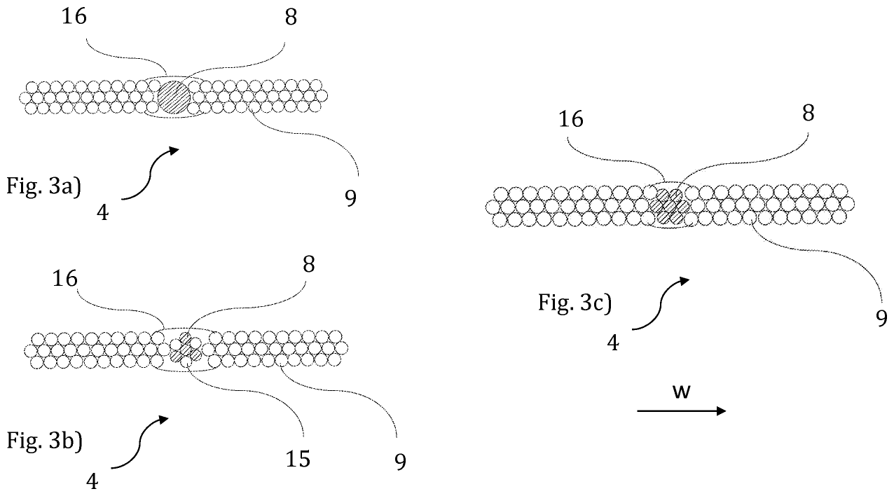

FIG. 3a), b) and c) show a top view in cross-section showing a strap structure 4. The strap structure 4 shown has a substantially flat rectangular shape. The substantially flat rectangular shape is made by the outer covering 9, which comprises elongated strands. In the width direction w of the strap structure 4 the one or more elongated optical fibers 8 are arranged to the central part of the strap structure 4. The both sides of the outer covering 9 extending in the width direction w of the strap structure 4 are connected with a connection material 16. The outer covering 9 may comprise a braided structure.

FIG. 3a) shows a strap structure 4 where a one elongated optical fiber 8 is arranged to the central part of the strap structure 4.

FIG. 3b) shows a strap structure 4 where the more elongated optical fibers 8 and the elongated flexible strengthening fibers 15 are arranged in a free order to the central part of the strap structure 4.

FIG. 3c) shows a strap structure 4 where a bunch of elongated optical fibers 8 is arranged to the central part of the strap structure 4.

The elongated covering strands of the outer covering 9 or part of them in FIGS. 2a)-c) and 3a)-c) can comprise reflective material or comprise a reflective surface to further intensify the illumination.

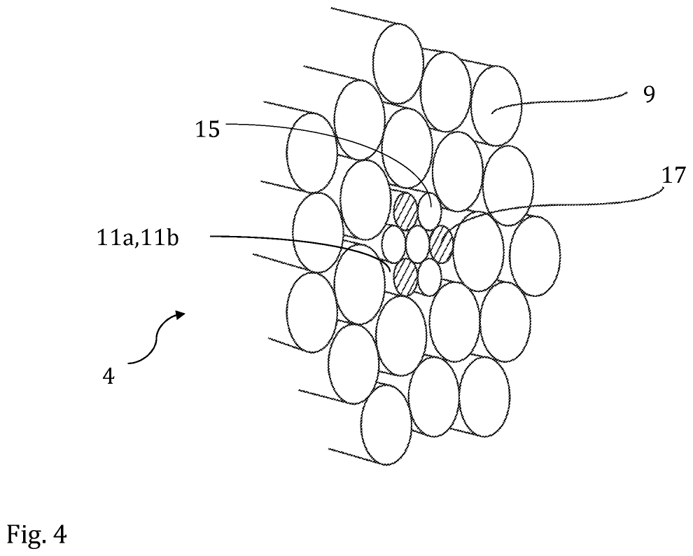

FIG. 4 shows an end 5a,b of the strap structure 4. The end 11a, 11b of one or more elongated optical fibers 8 is shown. The shown end may be the first 11a or the second end 11b of the one or more elongated optical fibers 8. The end 11a, 11b of one or more elongated optical fibers 8 comprises a reflecting layer 17 for reflecting the light back the one or more elongated optical fibers 8.

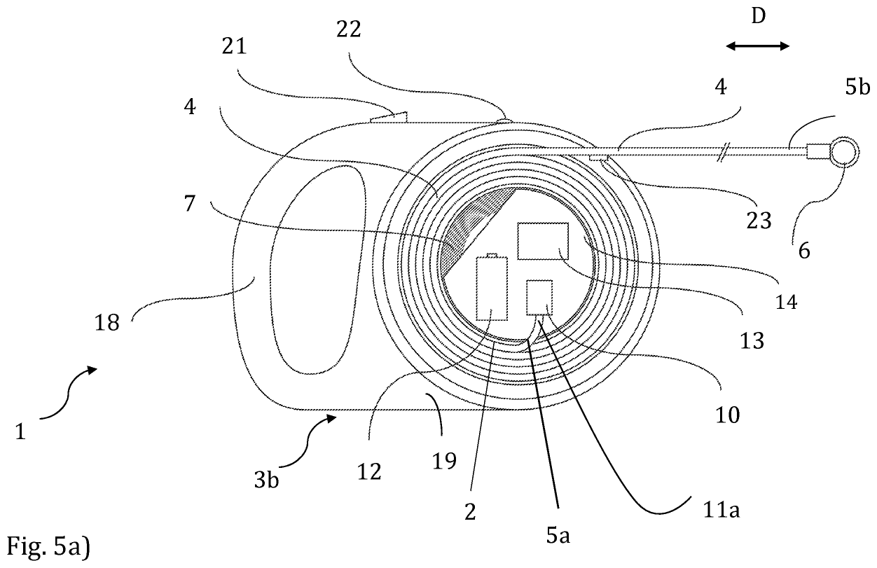

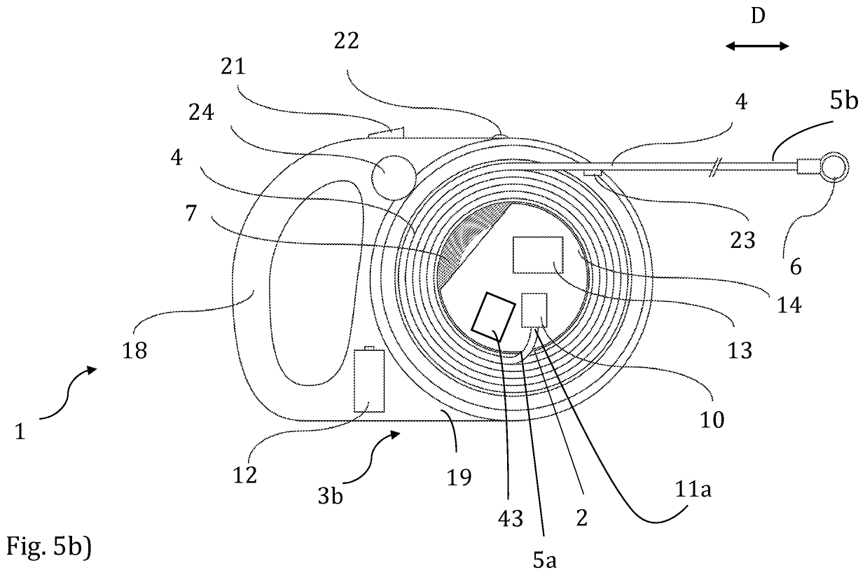

FIGS. 5a)-b) show an illuminated retractable strap assembly 1 comprising a housing 3b with a grip portion 18 having an opening for fingers. The assembly 1 is a handheld device. The assembly 1 shown in FIG. 5 is suitable for an animal tethering device, i.e. a retractable leash for animals. The connector in the second end of the strap structure is releasably attachable to a pet collar or to a pet harness.

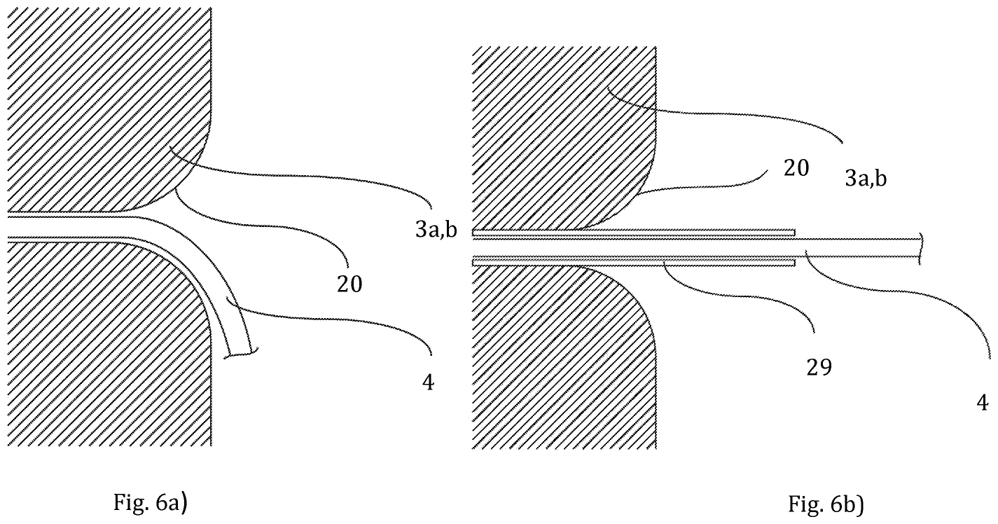

The assembly 1 comprises a rotatable strap spool 2. In the FIGS. 5a) and 5b) the rotatable strap spool 2 is arranged inside a housing 3b comprising a grip portion 18 and a support portion 19 for the strap spool 2. The strap spool 2 is positioned to the support portion 19 and the strap spool 2 is rotatably supported on the support portion 19. In the shown support portion 19, the strap spool 2 rotates around a horizontal axis. The support portion comprises a strap opening 20. One example of the strap opening 20 is shown in FIG. 6.

The strap structure 4 has a first end 5a which is fixed to the strap spool 2 and a second end 5b which has a connector 6 for connecting the strap structure 4. A retraction mechanism 7 retracts the strap structure 4 around the strap spool 2. The retraction mechanism 7 can comprise a spring biased element where during unwinding the spring tension increases and any slack of the strap structure 7 is retracted to the strap spool 2.

The strap structure 4 comprises one or more elongated optical fibers 8 for transmitting light between a first and a second end of the fibers. The strap structure can be any strap structure 4 described in connection with FIGS. 2a)-b) and 3a)-c).

The outer covering 9 allows at least part of the light originating from the one or more elongated optical fibers 8 to be transmitted through.

A light source 10 is arranged in connection to the first end 11a of the one or more elongated optical fibers 8. The light source 10 can also be arranged in connection to the second end 11b of the one or more elongated optical fibers 8. It is also possible the assembly comprises a first source 10 arranged in connection to the first end 11a of the one or more elongated optical fibers 8 and the second light source 10 is arranged in connection to second end 11b of the one or more elongated optical fibers 8.

A power source 12 is electrically connected to the light source 10 for powering the light source 10 and comprises a rechargeable power source 12 comprising a charging port. The light source 10 can be a light-emitting diode or a laser diode, for instance. The assembly 1 comprises electronics 13 for charging the power source and for controlling the light source 10.

The shown assembly 1 comprises a mounting surface 14 for the light source 10, the power source 12, and electronics 13. In FIG. 1 the mounting surface 14 is mounted to the center of the strap spool 2 and is rotating together with the strap spool 2.

The assembly 1 comprises a button operated stop mechanism 21 for stopping a rotation of the strap spool, and the button is provided on the outer surface of the housing.

The assembly 1 comprises an automatic twilight switch 22 for turning on and turning off the light source 10. The automatic twilight switch 22 is positioned to the upper part of the housing 3b. The automatic twilight switch 22 may also be operated manually to prevent undesired operation.

The assembly 1 comprises an automatic motion sensor 23 for detecting an unwinding and a retraction of the strap structure 4 where the unwinding is turning on and the retraction is turning off the light source 10. The motion sensor 23 can comprise a mechanical switch which is operated by an extension arranged to the strap structure 4 in a vicinity of the second end 5b of the strap structure 4. The motion sensor 23 can further comprise an optical sensor detecting a reflecting material arranged to the strap structure 4 in a vicinity of the second end 5b of the strap structure 4. The motion sensor 23 can also comprise an inductive sensor detecting a metal material arranged to the strap structure 4 in a vicinity of the second end 5b of the strap structure 4.

In FIG. 5b) shown illuminated retractable strap assembly 1 differs from the assembly 1 shown in FIG. 5a) in that the power source 12 is positioned to the support portion 19 of the housing 3b outside the strap spool 2. The power source 12 is not rotating together with the strap spool 2.

Additionally, FIG. 5b) shows also a dynamo 24 arranged in connection to the rotatable strap spool 2 for charging the rechargeable power source 12.

Additionally, FIG. 5b) shows also a position detector 43 for changing the colour of the light source 10

In the FIGS. 5a) and 5b) are described a rechargeable power source 12, a dynamo 24, a stop mechanism 21, an automatic twilight switch 22 and an automatic motion sensor 23. It is to be understood that it is not necessary for an illuminated retractable strap assembly 1 to comprise any of them but the illuminated retractable strap assembly 1 can comprise any of them or any combination of them or all of them.

FIG. 6a) shows a side view in cross-section of a strap opening 20 provided to a housing 3a,b. The strap opening 20 is widening outwards from the housing 3a,b for protecting the strap structure 4 from wear caused by an outer edge of the strap opening 20.

FIG. 6b) shows a side view in cross-section of a strap opening 20 provided to a housing 3a,b. The strap opening 20 is widening outwards from the housing 3a,b for protecting the strap structure 4 from wear caused by an outer edge of the strap opening 20. Additionally, the strap opening 20 comprises a flexible sleeve part 29 attached to the strap opening 20 and extending outwards from the housing 3a,b. The flexible sleeve part 29 provides additional protection to the strap structure 4 from wear caused by an outer edge of the strap opening 20.

In FIGS. 6a) and b) shown the strap opening 20 may also be provided to a support part 19 of a housing 3b as shown in FIGS. 5a) and 5b).

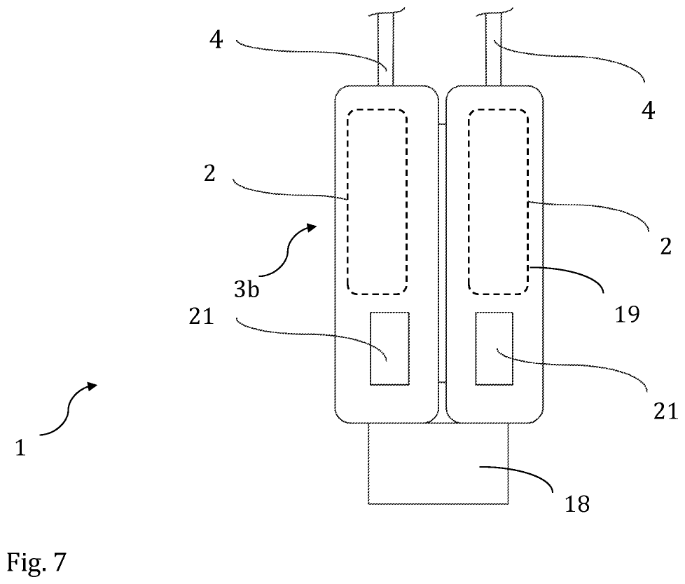

FIG. 7 shows a top view of an illuminated retractable strap assembly 1 comprising a housing 3b with a grip portion 18 and with two strap spools 2 each comprising a strap structure 4 with a connector 6. The strap spools 2 are shown with a dotted line. The housing 3b comprises the support portion 19 for the two separate strap spools 2. The support portion 19 may be a common support portion for the two rotatable strap spools 2, or the support portion 19 may comprise two separate support portions. In the housing the two strap spools 2 are positioned parallel within the support portion. The support portion of the housing comprises two strap openings 20, one for each strap structure 4.

Each strap structure 4 and strap spool 2 can comprise a separate power source 12 or a rechargeable power source 12, a dynamo 24, a stop mechanism 21, an automatic twilight switch 22 and an automatic motion sensor 23 or any of them or any combination of them. The previous components are described in detail in connection with FIGS. 5a) and 5b).

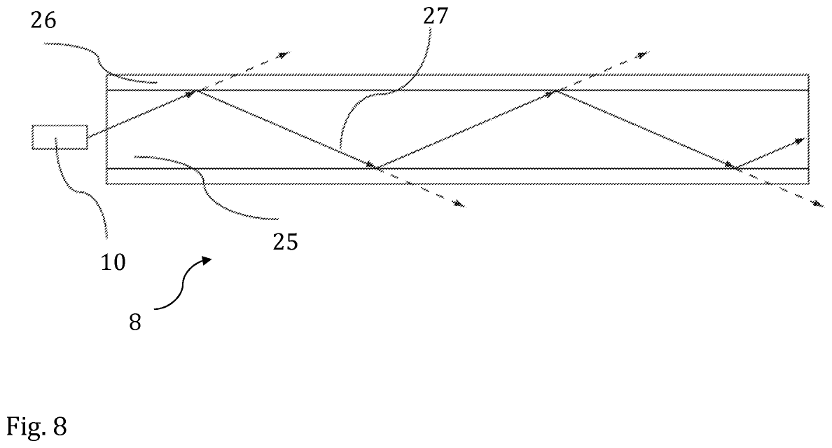

FIG. 8 shows an elongated optical fiber 8. The elongated optical fiber 8 is side emitting, i.e. a side glow optical fiber. The elongated optical fiber 8 comprises a core 25 and a cladding 26. A light source 10 is arranged in connection of a first end 11a of the elongated optical fiber 8 for generating light into the elongated optical fiber 8. A light beam 27 travels in the direction of the core 25 and part of the light is escaping from the side of the elongated optical fiber 8 through the cladding 26. Part of the light is escaping from the second end 11b of the elongated optical fiber 8 which phenomina is called an end glow. The side emitting, i.e. the side glow elongated optical fiber can comprise a plastic optical fiber where the core material is PMMA and the cladding material comprises fluorinated polymers, for instance.

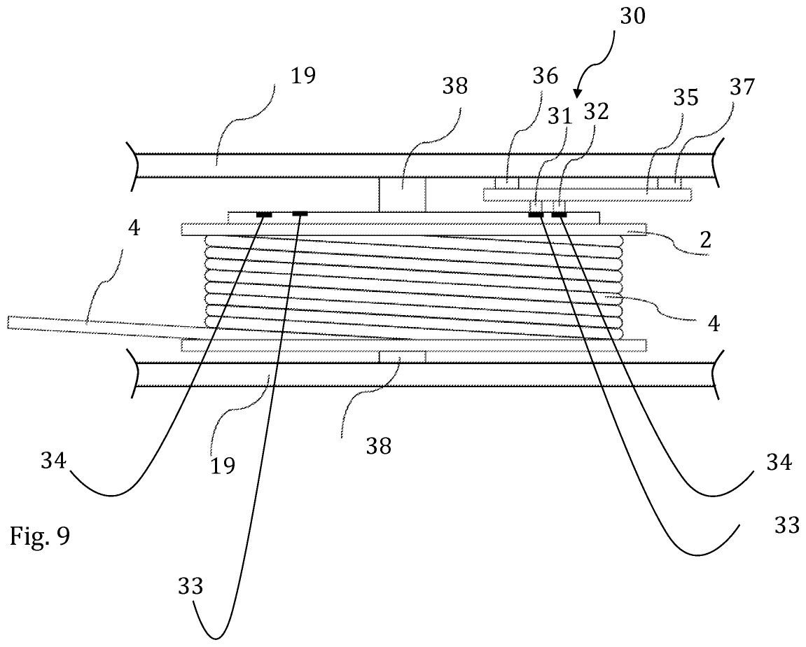

FIG. 9 shows a rotating electrical connector 30. The rotating electrical connector 30 is arranged to conduct electric power from a charging port or from the power source to the rotatable strap spool 2. Electric power is arranged to the rotatable strap spool 2 when the light source 10 is in connection to a first end 11a of the elongated optical fiber 8. In other words the rotating electrical connector 30 conducts electric power to the light source 10 when the light source 10 is fixed to the rotatable strap spool 2.

For instance, the rotating electrical connector 30 comprises a first strap spool contact 31, a second strap spool contact 32, a first circular electric connector 33, a second circular electric connector 34, a connector board 35, a first connector board fixing 36 and a second connector board fixing 37. The rotatable strap spool 2 is positioned to the support portion 19 and rotates around a horizontal axis 38. The first and the second circular electric connector 33, 34 and the rotatable strap spool 2 are coaxial with each other.

The connector board 35 is electrically connected with the power source or with the charging port. The connector board 35 is arranged to conduct electric power to the first and the second strap spool contact 31, 32.

The first and the second strap spool contact 31, 32 further conducts electric power to the first circular electric connector 33 and to the second circular electric connector 34. The first and second strap spool contact 31, 32 are fixed to the connector board 35. The first and second strap spool contact 31, 32 are arranged to rub the first and the second circular electric connector 33, 34. The light source 10 is electrically connected with the first and the second circular electric connector 33, 34.

In an alternative embodiment the first and the second circular electric connector 33, 34 are arranged to the connector board 35 and the first and second strap spool contact 31, 32 are fixed to the rotatable strap spool 2.

In other words the first and the second strap spool contact 31, 32 conduct electric power from the connector board 35 to the first and the second circular electric connector 33, 34 when the strap spool 2 rotates.

In one embodiment the connector board 35 is fixed to the support portion 19 with the first and the second connector board fixing 36, 37.

In one embodiment the rotating connector 30 conducts electric power from a charging port to a rechargeable power source which is fixed to the rotatable strap spool 2.

In one embodiment the first and second strap spool contact 31, 32 comprise a strap spool contact spring to improve electrical contact between the first and the second circular electric connector 33, 34 and the connector board 35.

In one embodiment the first and second strap spool contact 31, 32 comprise a strap spool brush to improve electrical contact between the first and the second circular electric connector 33, 34 and the connector board 35.

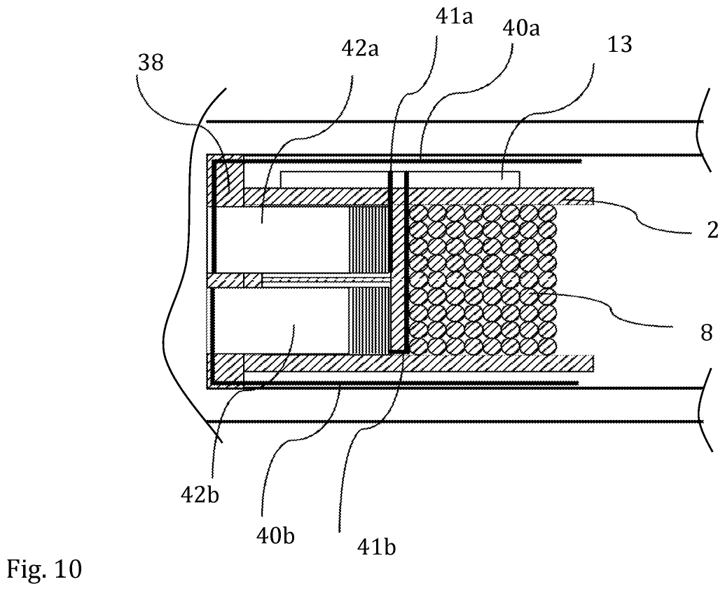

FIG. 10 shows a combined retraction mechanism and electric power conductor. The combined retraction mechanism and electric power conductor comprises a first spring biased element 42a and a second spring biased element 42b which conduct electric power to the rotatable strap spool 2. The first and the second spring biased element 42a, 42b also provide a capability of automatically winding the strap structure to the strap spool. Electric power is arranged to the rotatable strap spool 2 when the light source 10 is in connection to a first end 11a of the elongated optical fiber 8. In other words the combined retraction mechanism and electric power conductor conducts electric power to the light source 10 when the light source 10 is fixed to the rotatable strap spool 2.

The combined retraction mechanism and electric power conductor further comprises a first electrical conductor 40a, a second electrical conductor 40b, a third electrical conductor 41a and fourth electrical conductor 41b.

The first and the second electrical conductor 40a, 40b are electrically connected with a charging port or with a power source 12, and with the first and the second spring biased element 42a, 42b.

The first and the second spring biased element 42a, 42b are electrically conductive material.

The third and fourth electrical conductor 41a, 41b are electrically connected with the first and the second spring biased element 42a, 42b. The third and fourth electrical conductor 41a, 41b conduct electric power form the first and the second spring biased element 42a, 42b to the light source 10 or to electronics 13 which are fixed to the rotatable strap spool 2.

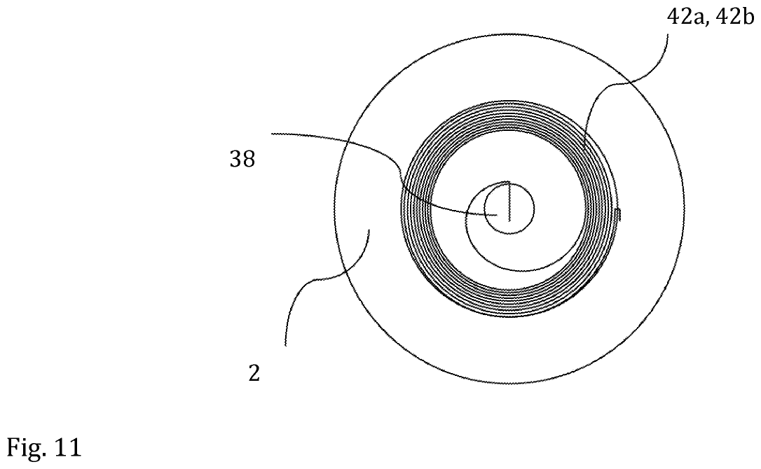

In one embodiment the first and second spring biased elements 42a, 42b are joined together with an electrically isolated material. FIG. 11 shows a spring biased element of a retraction mechanism. The first and the second spring biased element 42a, 42b are arranged between the horizontal axis 38 and the rotatable strap spool 2. The first and the second spring biased element 42a, 42b are parallel to each other. The first and the second spring biased element 42a, 42b are fixed to the horizontal axis 38 and to the rotatable strap spool 2. The horizontal axis 38 is fixed unrotatable to the support portion 19.

The invention has been described above with reference to the examples shown in the figures. However, the invention is in no way restricted to the above examples but may vary within the scope of the claims.

Part list: 1 an illuminated retractable strap assembly; 2 a strap spool; 3a-b a housing; 4 a strap structure; 5a-b a strap end; 6 a connector; 7 a retraction mechanism; 8 an optical fiber; 9 a covering; 10 a light source; 11a-b an optical fiber end; 12 a power source; 13 electronics; 14 a mounting surface; 15 a strengthening fiber; 16 a connection material; 17 a reflecting layer; 18 a grip portion; 19 a support portion; 20 a strap opening; 21 a stop mechanism; 22 a twilight switch; 23 a motion sensor; 24 a dynamo; 25 a core; 26 a cladding; 27 a light beam; 29 a sleeve part; 30 a rotating electrical connector; 31 a first strap spool contact; 32 a second strap spool contact; 33 a first circular electric connector; 34 a second circular electric connector; 35 a connector board; 36 a first connector board fixing; 37 a second connector board fixing; 38 an horizontal axis; 40a a first electrical conductor; 40b a second electrical conductor; 41a a third electrical conductor; 41b a fourth electrical conductor; 42a a first spring biased element; 42b a second spring biased element; 43 position detector. D direction of a travel; w width direction.

1.-15. (canceled)

16. An illuminated retractable strap assembly, the assembly comprising a rotatable strap spool, a strap structure comprising a first end fixed to the strap spool and a second end comprising a connector, wherein the assembly comprises:
retraction mechanism for retracting the strap structure around the strap spool,
the strap structure comprises one or more elongated optical fibers for transmitting light between a first and a second end of the one or more elongated optical fibers and an outer covering,
the outer covering allowing at least part of the light originating from the one or more elongated optical fibers to be transmitted through,
a light source arranged in connection to the first end or to the second end of the fibers, and
a power source electrically connected to the light source.

17. The illuminated retractable strap assembly according to claim 16, wherein:
the strap structure comprises elongated flexible strengthening fibers, and
the elongated flexible strengthening fibers are arranged to surround the one or more elongated optical fibers, or
the elongated flexible strengthening fibers and the one or more elongated optical fibers are arranged to form a bundle.

18. The illuminated retractable strap assembly according to claim 16, wherein the assembly comprises:
a reflector arranged in connection to the first or the second end of the one or more elongated optical fibers where the other of the first and the second ends comprises the light source, or
the first end or the second end of the one or more elongated optical fibers comprises a reflecting layer where the other of the first end and the second ends comprises the light source.

19. The illuminated retractable strap assembly according to claim 16, wherein:
the light source comprises a light-emitting diode or a laser diode.

20. The illuminated retractable strap assembly according to claim 17, wherein:
a material of one or more elongated flexible strengthening fibers comprises polyethylene, ultra-high-molecular-weight polyethylene or polypropylene, and/or
the elongated flexible strengthening fiber stretches less in the length direction than the one or more elongated optical fibers.

21. The illuminated retractable strap assembly according to claim 16, wherein:
the outer covering is transparent, translucent and/or comprises a braided structure.

22. The illuminated retractable strap assembly according to claim 16, wherein the assembly comprises:
the power source comprises a rechargeable power source,
the rechargeable power source comprises a charging port, and
electronics for charging.

23. The illuminated retractable strap assembly according to claim 22, wherein the assembly comprises:
a dynamo arranged in connection to the rotatable strap spool for charging the rechargeable power source.

24. The illuminated retractable strap assembly according to claim 16, wherein the assembly comprises:
the strap structure has a round cross-section, or
the strap structure has a flat rectangular cross-section, or
the strap structure has an elliptical cross-section, or
the strap structure has a polygonal cross-section.

25. The illuminated retractable strap assembly according to claim 16, wherein the assembly comprises:
a housing comprising a grip portion and a support portion for the strap spool,
the strap spool is positioned within the support portion and the strap spool is rotatably supported on the support portion,
the support portion comprises a strap opening.

26. The illuminated retractable strap assembly according to claim 25, wherein:
the strap opening is widening outwards from the support portion, and/or
the strap opening comprises a flexible sleeve part attached to the strap opening and extending outwards from the support portion,
for protecting the strap structure from wear caused by an outer edge of the strap opening.

27. The illuminated retractable strap assembly according to claim 25, wherein the assembly comprises:
a button operated stop mechanism for stopping a rotation of the strap spool, and
the button provided on the outer surface of the housing.

28. The illuminated retractable strap assembly according to claim 16, wherein:
the light source is arranged in connection to the first end of the one or more elongated optical fibers,
the strap spool comprises a mounting surface for the light source, the power source, and electronics for controlling the light source,
the mounting surface is mounted to the center of the strap spool and is rotating together with the strap spool.

29. The illuminated retractable strap assembly according to claim 16, wherein the assembly comprises:
an automatic twilight switch for turning on and turning off the light source, and/or
an automatic motion sensor for detecting an unwinding and a retraction of the strap structure where the unwinding is turning on and the retraction is turning off the light source.

30. The illuminated retractable strap assembly according to claim 16, wherein the assembly comprises:
two or more rotatable strap spools,
the housing is providing support for the two or more separate strap spools,
the two or more strap spools are positioned parallel or are arranged in a stack within the housing, and
the housing comprises two or more strap openings.
